(19) United States
(12) Patent Application Publication
(10) Pub. No.: US 2002/0194295 A1
(43) Pub. Date: Dec. 19, 2002

(54) Scalable data-sharing architecture

(75) Inventors: Jacques Mercure, Montreal (CA); Yves Barrette, Montreal (CA); Luc Mercure, Montreal (CA)

Correspondence Address: OGILVY RENAULT, 1981 MCGILL COLLEGE AVENUE, SUITE 1600, MONTREAL, QC, H3A2Y3, CA

(73) Assignee: GROUPE 2MB INC.

(21) Appl. No.: 09/881,580

(22) Filed: Jun. 15, 2001

(51) Int. Cl. G06F 15/16

(52) U.S. Cl. 709/217

(57) ABSTRACT

This invention relates to a scalable data-sharing architecture. A user is able to access the system via a Wide Area Network (WAN). The user may create data and access data shared by the other users. In the preferred embodiment, the data are stored using databases. The architecture comprises a dispatch server, more than one cells, more than one drive servers and more than one email servers. The architecture provides to the user a user interface which allows him to access its ressources in a flexible way.

### FIELD OF THE INVENTION

This invention relates to a scalable architecture that enables a user to share data with a plurality of users.

### BACKGROUND OF THE INVENTION

With the growth of Wide Area Networks (WAN) and more particularly with Internet, users now desire to access simultaneously more and more applications, For instance, users may wish to check their email, store files over the Internet, create database of contacts, browse their agenda, etc. Furthermore, users now wish to share information on a peer to peer basis.

Users may wish to be connected to the Internet using a high bandwidth connection such as cable or xDSL modem, users may also wish to be connected using a regular, low speed modem. Nomadic users, alternatively, wish to be connected using a WAP compatible handheld.

Unfortunately, providing more than one applications over such heterogeneous population of users is not an easy task.

Furthermore, security issues are very important. The users must access the applications in a secure way with an authentication process.

Many popular single applications are available over the Internet. For instance, Hotmail (http://www.hotmail.com) provides email to its users using a web interface; Bitlocker (http://www.bitlocker.com) provides its users the ability to create and manage databases. Many other services also provide hard drive space in order to enable users to store their files. Unfortunately, no single application successes to meet the needs for an integration of all the above mentioned applications, as well as the needs for a secure access to an heterogeneous population of users ranging from nomadic to fixed users.

### SUMMARY OF THE INVENTION

It is an object of the invention to provide a multi-application architecture to a user over a network.

It is another object of the invention to provide a scalable multi-application architecture to a user over a network.

Yet another object of the invention is to provide a scalable multi-application architecture to a user which may evolves dynamically.

It is another object of the invention to provide a scalable multi-application architecture that allows information sharing amongst users.

Yet another object of the invention is to provide a multi-application architecture to a user over a network with authentication means.

According to one aspect of the invention, there is provided a method for sharing at least one part of data among at least one user with permission rights over a Wide Area Network (WAN), each of the users having a user identification, the method comprising the steps of accessing a dispatch server, the dispatch server comprising a look-up table, the look-up table providing a relation between a user identification and a cell identification, providing a user identification to the dispatch server, receiving, from the dispatch server, a cell identification corresponding to the user identification provided, accessing a cell through the WAN, using the cell identification, authenticating with the cell using at least the user identification and a password, selecting the at least one part of data to share, selecting the at least one user to whom said at least one part of data is shared and a permission right, updating a permission database using at least the permission right, the user identification of the at least one user to whom the at least one part of data is shared and an identification of the shared data.

According to another aspect of the invention, there is provided a computer network for storing user data and sharing at least a part of same among users with permission rights over a Wide Area Network (WAN), each of the users having a user identification, the computer network comprising a dispatch server, the dispatch server comprising a look-up table, the look-up table providing a relation between a user identification and a cell identification at least one cell, each of the at least one cell comprising, an owner authentication unit, connected to the WAN, authenticating a local user and providing an owner authentication signal, a shared database, the shared database comprising the shared data, a permission database, the permission database comprising a relation between at least one user identification, at least one part of the data and the permission rights, a shared access authentication unit, connected to the WAN, the shared access authentication unit authenticating a non local user using the permission database and providing a shared access authentication signal, a database manager, connected to at least the owner authentication unit, to the shared access authentication unit, to the permission database and to the shared database, the database manager, receiving a request from a user and providing an access with permission right to at least one part of the shared data of the shared database with the permission rights if an owner authentication signal or if a shared access authentication signal is received.

### BRIEF DESCRIPTION OF THE DRAWINGS

The invention will be better understood by way of the following description of specific preferred embodiments, together with the accompanying drawings, in which;

FIG. 1 is a block diagram which shows the hardware architecture of one embodiment of the present invention; a firewall protects a local area network (LAN) from incoming traffic from the Internet or from a WAP gateway;

FIG. 2 shows a block diagram of the different element of the architecture in one embodiment of the present invention; the architecture comprises an authentication server, more than one cells, more than one drive servers and more than one email servers;

FIG. 3 is a flow chart which shows the different steps for a login procedure; a first part of the login procedure is performed using the dispatch server; the second part of the login procedure is performed using the cell where the user is hosted;

FIG. 4 is a table which shows the different elements that are comprised in a cell; a cell comprises an identification, administrative tools, and data,

FIG. 5 is a table which shows the different elements that are comprised in a drive server; a drive server comprises an identification, administrative tools and data;

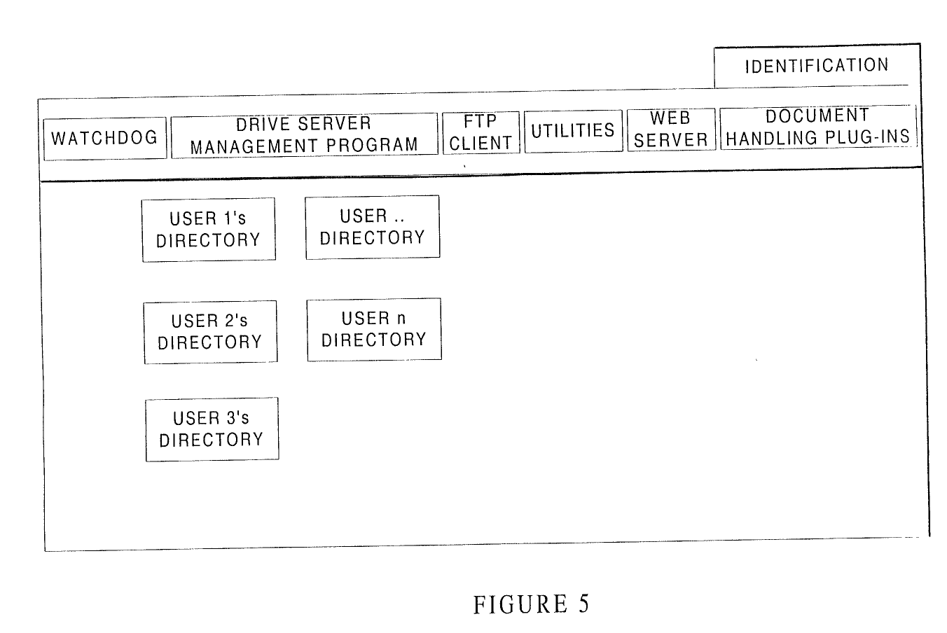

FIG. 6 is a table which shows the different elements that are comprised in an email server; the email server comprises an identification, administrative tools and an index;

FIG. 7 is a block diagram which shows the functional elements of a cell in the preferred embodiment of the invention; the cell is connected to the Internet.

FIG. 8 is a screenshot which shows one embodiment of the user interface; the user interface comprises a list of available applications, information related to available databases and a dynamic search engine.

FIG. 9 is a block diagram which shows various applications connected to the owner resource access manager;

### PREFERRED EMBODIMENT

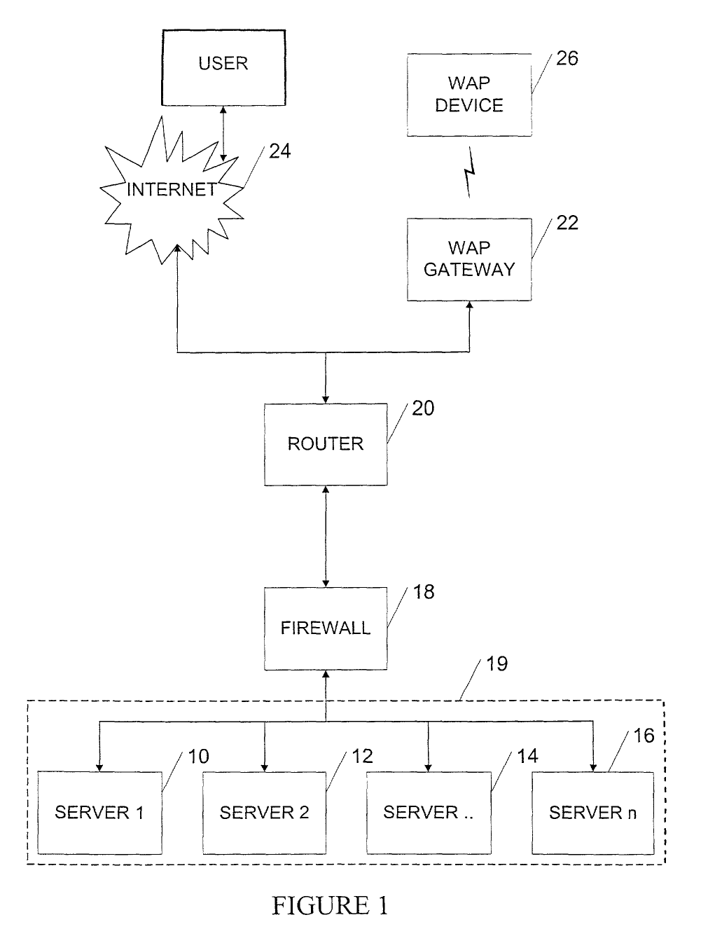

Now referring to FIG. 1, there is shown one embodiment of the hardware architecture. The hardware architecture comprises in the preferred embodiment a WAP gateway 22, a router 20, a firewall 18 and more than one servers 19. The WAP gateway 22 allows a communication between a WAP-enabled client and the more than one servers 19. It will be appreciated that the invention is not limited to be used in a wireless WAP environment. The invention may be provided to I-mode users. The router 20 allows the communication between a user connected to the Internet 24 and the more than one servers 19. The firewall 18 filters, as explained below, the incoming as well as the outgoing traffic between the more than one servers 19 and either a client connected to the Internet or a WAP-enabled client 26. The more than one servers 19 are linked using an Ethernet 100 Mb/s network in the preferred embodiment of the invention,

Still referring to FIG. 1, and in the preferred embodiment of the invention, the firewall 18 allows only Internet port numbers 25, 80 and 88 to enter in the more than one server network 19. Such policy provides a security to the system against intruders. The gateway transmits data either to the WAP gateway 22 or to the Internet 24 depending on the location of the user. In one embodiment of the present invention, one server of the more than one servers 19 is an Intel Pentium III with a Random Access Memory (RAM) of 768 MB and which runs under Microsoft Windows NT server; in another embodiment of the present invention, one server of the more than one servers 19 is an Apple G4 with a Random Access Memory (RAM) of 768 MB and which runs under Mac OS9/10.

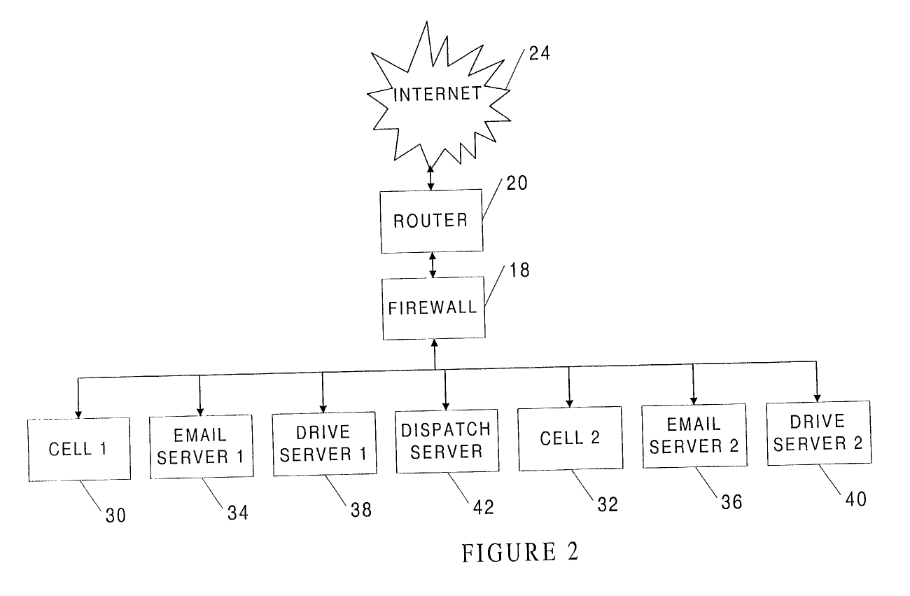

Now referring to FIG. 2, there is shown one embodiment of the present invention. In this embodiment of the invention, the architecture comprises a first cell 30, a first email server 34, a first drive server 38, a second cell 32, a second drive email server 36, a second drive server 40 and a dispatch server 42. In this embodiment two cells are shown, however the architecture by its essence is not limited to these two cells and may be easily scalable as explained below.

The dispatch server provides a connection between a client station connected to the system via either the Internet or via a WAP gateway and a cell.

A cell such as cell 30, hosts a predetermined number of users. A user in such a cell may create and share information to other users of the system as explained below.

A drive server, such as drive server 38 is connected to a cell in the preferred embodiment, the drive server allows a user of a cell to store data on the system. It will be appreciated that any type of data may be stored in the system.

An email server, such as email server 34 is connected to a cell and to a drive server. The email server is used by a user, hosted in the cell to which the user is connected, to check email accounts. In the preferred embodiment of the present invention, emails may also be created by the user using existing email account(s). Attachments received with the email are stored on the drive server to which the email server is connected.

Login Procedure

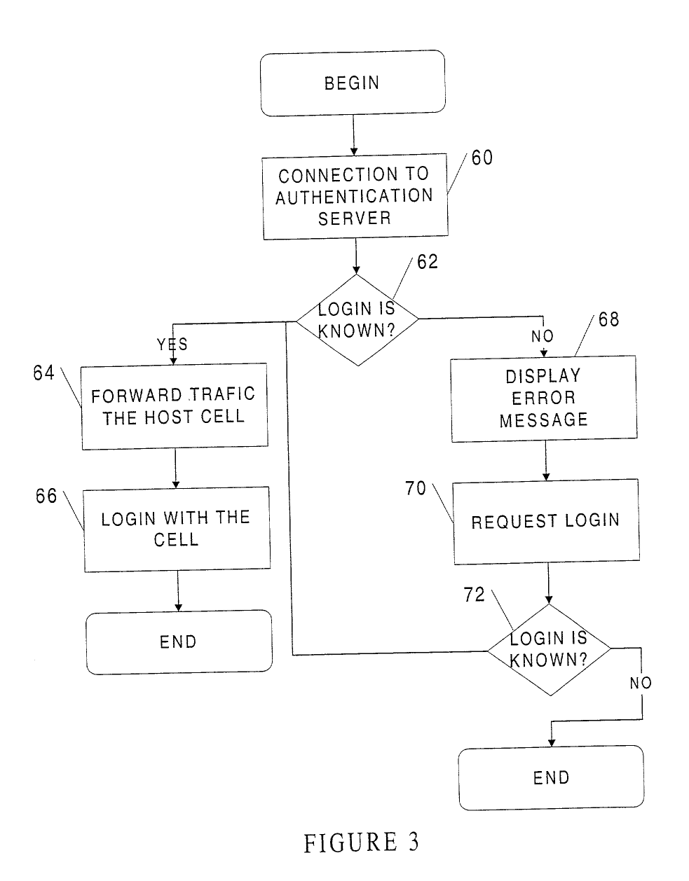

Now referring to FIG. 3, there is shown the login procedure. According to step 60 of the present invention, the user by entering a web address on its web browser connects its computer to the dispatch server 42. In the preferred embodiment of the present invention, the dispatch server 42 is hosted by one of the more than one servers 19. In the preferred embodiment of the present invention, the dispatch server 42 works with Microsoft Internet Information Server (IIS). The dispatch server 42 comprises a user database which comprises a list of all the logins and the address of their hosting cell. According to step 62, the user enters its login and a look-up is performed over the user database with the entered login. If the login is located inside the user database, and according to step 64 of FIG. 3, a connection is set-up with the cell where the user is hosted. According to step 66, the user may then enter its password and the login; the password submitted is checked against the user cell info database, which is located inside the cell where the user is hosted. It will be therefore appreciated that the dispatch server 42 does provide an indication on where the user is hosted if the user is hosted in one cell; the complete login procedure is performed with the cell where the user is hosted, If the login is not known and according to step 68, an error message is displayed on the screen. According to step 70, the login is re-requested. It will be appreciated that the login is therefore performed by the cell itself which hosts the user. In another embodiment of the present invention, the login is performed by a dedicated login server. The dedicated login server, may send upon complete login procedure a signal to the cell which hosts the user in order to inform it from the login.

Structure of One Cell

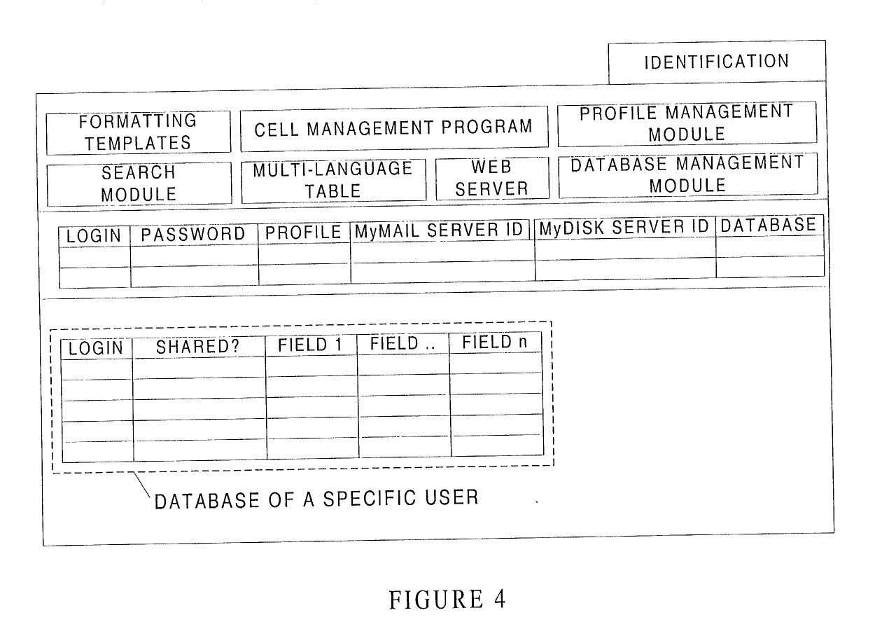

Now referring to FIG. 4, there is shown one embodiment of a cell. A cell hosts a pre-determined number of users with their databases. The cell also authenticates a user as explained before.

When authenticated, the cell provides pertinent authentication and localization data about a particular user to either the drive server of the particular user if the drive server of the particular is accessed or to the email server of the particular user if the email server of the particular user is accessed.

The cell comprises an identification element, administrative tools, an index and data. The identification element allows the server which hosts the cell to be accessed over a network; in the preferred embodiment of the present invention, the identification element is the IP address of the server which hosts the cell. In another embodiment of the invention, the identification element is a domain name.

The administrative tools comprise formatting templates, a search module, a cell management program, a multi-language table, a web server, a profile management module and a database management module.

The formatting templates are used in order to create the user databases, “check-boxes” for instances are part of the formatting templates. The search module allows a user to perform a search in a database. The cell management program handles all requests that involves the cell and operates, depending on its operation, with at least one other element from the administrative tools. The multi-language table allows to customize the user's graphics interface according to the user's preferences. In the preferred embodiment of the present invention, the multi-language table provides a support for English, French, Spanish, etc. The web server allows the cell to send to the user's client station requested information using a graphics interface. For instance, a user might request to view the content of one of its database, a shared database, etc. In the preferred embodiment of the present invention, the web server is 4D web server. The profile management module allows a user to modify its profile; a user may wish for instance to update its “snail mail” address for example. The database management module allows a user to perform operations on its databases. A user may, for instance, create a new database with desired fields, access, add, delete or modify entries of an existing database, share a database with another user, defines sharing rights.

The index of the cell comprises a database of the users hosted by the cell. The database of the users hosted by the cell comprises for each registered user of the cell, its login, its password, its profile information, the email server's identification of the email server which handles the email account(s) of this specific user, the drive server's identification of the drive server which stores the files of this specific user and parameters to access databases which can be accessed by the user. In the preferred embodiment of the present invention, the databases which can be accessed by the user comprises the databases created by the user and hosted by the cell and the databases of other users shared to this user. The parameters to access databases comprise the name of the database, the identification of the cell which hosts the databases and the permission rights for this database. The permission rights comprises but are not limited to reading access/writing access.

The data of the cell comprises all the databases created by a registered user which is hosted by the cell. It will be appreciated that the data of a user are included in a database. For instance, the emails are embedded in an email database, each email being an entry of the email database. Therefore, as the user may share databases, any type of information owned by a user may be shared.

It will be appreciated that a database comprises various type of fields. A user might create his own fields. In one embodiment of the invention, a user might use an “alarm field” in a database. An “alarm field” enables a user to set an alarm to a condition. For example, a user might create a database for his own cellar, The database comprises fields such as the physical identification of the bottle, the name of the vineyard, the year, the rate of the bottle, the number of bottle and the “alarm field”. The “alarm field” might be set to contact the user when a condition is fulfilled. In this particular embodiment, the condition may be the time to drink the wine as would advice someone skilled in the Art. When the condition is fulfilled, the “alarm field” triggers an event. A notification may be post when the user is log in, an email may be sent, etc. An “alarm field” comprises a variable to check, a limit set, and an event to perform when the variable reaches the limit set. In the preferred embodiment of the invention, the watchdog located in each cell monitors the “alarm fields” located on the databases of the cells.

Structure of a Drive Server

Now referring to Fig, 5, there is shown one embodiment of the drive server. Each drive server comprises an identification element, administrative tools and data.

The identification element allows the server which hosts the drive server to be accessed over a network; in the preferred embodiment of the present invention, a the identification element is the IP address of the server which hosts the drive server, In another embodiment of the invention, the identification element is a domain name.

The administrative tools of the drive server comprise a watchdog, a drive server management program, a file transfer protocol client (FTP), a web server and a documents handling plug-ins.

The watchdog allows the drive server to monitor for instance that no virus compromise the drive server for instance. The drive server management program enables the drive server to operate. More precisely, the program manages the connection as well as the transfer of data between a user and the drive server; it also manages the connection as well as the transfer of data between a cell or an email server and the drive server. The FTP client allows the drive server to download/upload a file. The web server allows the drive server to directly send to the user requested information using a graphics interface; the web server also allows to receive information from a user. In the preferred embodiment of the present invention, the web server is Microsoft Internet Information Server (IIS). The web server works with the document handling plug-ins. In the preferred embodiment of the invention, the document handling plug-ins is ASP Upload. The document handling plug-ins allows for instance to store a file provided by a user in the graphics interface to the drive server.

The data of the drive server comprise all the files of a user, In the preferred embodiment of the present invention, all the files of a particular user are stored in the same directory.

Structure of an Email Server

In the preferred embodiment of the present invention, the email server allows basically a user to check various existing email accounts and reply to emails.

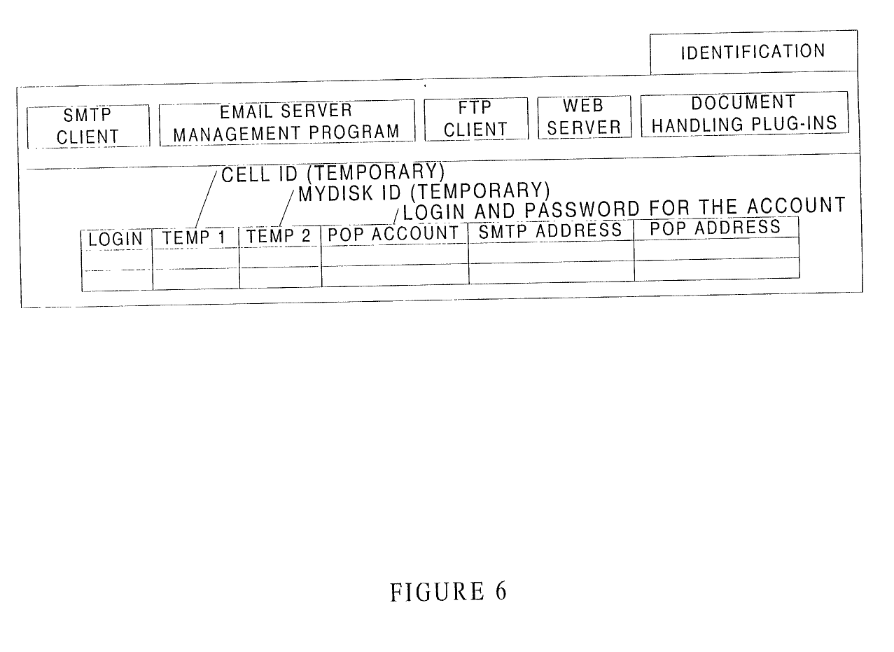

Now referring to FIG. 6, there is shown one embodiment of the email server. Each email server comprises an identification element, administrative tools and an index.

The identification element allows the server which hosts the email server to be accessed over a network; in the preferred embodiment of the present invention, the identification element is the IP address of the server which hosts the email server. In another embodiment of the invention, the identification element is a domain name.

The administrative tools comprise a Simple Mail Transfer Protocol client (SMTP client), an email server management program, a FTP client, a web server and a documentation handling plug-ins.

The SMTP client allows the email server to check an email account located on a remote server. The email server management program allows the email server to communicate. For instance the email server management program allows a connection with a client station unit using the web server. The email server management program allows a data transfer between the email server and SMTP servers, this is performed using at least the SMTP client; the email server management program also allows a data transfer between the email server and the cell to which the email server is linked; finally the email management program allows a data transfer between the email server and the drive server to which it is connected. The FTP client allows the email server to transfer a file to the drive server to which the email server is connected. The web server allows the email server to display information to the user's client station using a graphics interface, The information displayed are detailed below. The web server is, in the preferred embodiment of the present invention, Microsoft Internet Information Server (IIS). In the preferred embodiment of the present invention, the administrative tools comprise a document handling plug-ins. In the preferred embodiment of the present invention, the document handling plug-ins is ASP Upload. The document handling plug-ins works with the web server in order to allow a user to upload a file to the email server. The uploaded file may be used as an attachment for an email.

The index of the email server is a database of the users registered at this email server. The database of the users registered at this email server comprises for each entry the login of a user, the POP/SMTP parameters of the user's email account and temporary fields, The temporary fields comprise the identification element of the drive server of the user and the identification element of the cell which hosts the user.

In the preferred embodiment of the present invention, each email read by a user is stored as one entry of an email database on the user's cell. In another embodiment of the present invention, the email database of an user is stored in the email server of the user.

Expanding the System

The system is by essence easily expandable; a new cell may be added by simply assigning it an identification element. This identification element has to be unique. When users register to this new cell, the identification element as well as the login of the users is sent by the cell to the dispatch server. A new drive server as well as a new email server may be also added; the new drive server as well as the new email server needs to get a unique identification element. The identification elements of the drive server as well as the identification element of the email server must be transmitted to the cell where the user is.

In another embodiment, a watchdog enables a cell to transfer dynamically an amount of database shared by users on another cell when the cell reaches a certain threshold. The threshold may be set-up using the traffic which reaches the cell or using the physical size of the shared databases on the cell. The other cell may be chosen using various criteria. One of the criteria is the physical location of the another cell; another criterion is the amount of data comprised in the shared database of the another cell; another criteria is the amount of clients connected to the another cell. When data is transferred from one cell to another, an update is performed on the dispatch server; the update comprises, the step of changing, in the dispatch server, the identification of the cell which hosts the owner of the data which is moved with the identification of the new cell which is selected to receive the data. The permission database of the new cell is also updated with the permission data of the data which is moved.

Accessing the Email Server

The client station of a user who wishes to access an email server must authenticate with its cell first. Upon authentication, and when the user selects the email menu, a request is performed by the cell to the email server which handles the email accounts of the user. The request comprises the login of the user and its physical location. In another embodiment, the request might comprise the name of the email account the user wish to access in case that the user owns multiple email accounts. If the request is accepted, the email server is connected directly with the user's client station using the web server of the email server. The user's client station may then check, write, delete emails on its account. It will be appreciated that the temporary fields of the database of the users hosted by the email server are updated with the cell identification and with the IP address of the user client station. In the preferred embodiment of the present invention, an email read by a user is then sent to its email database on the user's cell. The email database also comprises, in the preferred embodiment, the emails sent by the user. In the preferred embodiment, the email server receives the requests of the users to which it is connected in a stack. The requests of the users comprises email checking requests and email sending requests. In the preferred embodiment of the invention, the requests are handled , by the email server, on a first in, first out basis. In another embodiment of the present invention, a security feature might be used to ensure the authenticity of the users client station.

Functional Description of a Cell

For the sake of the explanation, client A is the owner of database 94, client B is unknown to the cell and wishes to access information shared by client A.

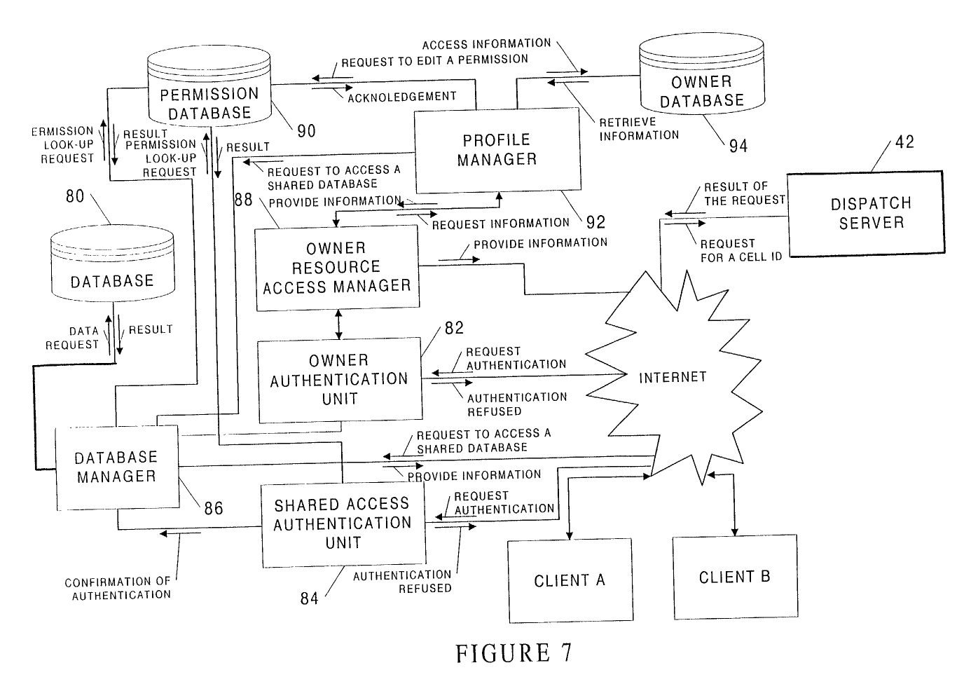

Now referring to FIG. 7, there is shown the functional elements of a cell, A cell comprises a database 80, a owner authentication unit 82, a shared access authentication unit 84, a database manager 86, a owner resource access manager 88, a permission database 90, a profile manager 92 and a owner database 94.

A User Accesses his own Information on his Cell

Client A wishes to access his information located on the cell. Client A sends a request to access his cell. The request comprises his login. The request is sent to the dispatch server 42. The dispatch server 42 which comprises a table with all the login and the corresponding cell identification, The dispatch server 42 transmits the corresponding cell identification to client A. In the preferred embodiment of the present invention and as explained above, the cell identification comprises the IP address of the cell.

The client A then sends a request to authenticate with his cell. The request comprises his login and his password. The request is handled by the owner authentication unit 82. If the authentication is successful, the owner authentication unit 82 sends a request for his accessible information by the authenticated client A to the owner resource access manager. The request for his accessible information comprises, in the preferred embodiment of the present invention, the IP address of client A and his login. The owner resource access manager 88 provides to the client A his accessible information. The information is provided using the IP address of client A. The information comprises the databases owned by client A or shared to the client A. The information is retrieved using the profile manager 92 to which a profile request is sent. The profile request comprises the login of client A. The profile manager accesses a owner database 94 of client A. The owner database 94 comprises the name of the databases available to client A as well as the owner. The information accessed in the database 94 of client A are then forwarded to the owner resource access manager 88. The information accessed in the databases are then sent by the owner resource access manager 88 to the client A using the Internet. Client A is then aware of all the resources he is allowed to access. In the preferred embodiment of the invention, the information is sent using a secure connection. In the preferred embodiment of the invention, the secure connection is performed using Secure Socket Layer (SSL). Client A may then make a request to access a database. Client A makes a request to the database manager 86 to access a chosen database. The database manager 86 may then check with the owner authentication unit that client A has already been authenticated. As this is the case, the permission database 90 is then accessed by the database manager 86 and an access to the one database 80 is then allowed if the request matches with the rights allowed to client A. In another embodiment of the invention, the permission database is accessed during the authentication.

A User of a Cell Accesses Shared Information on his Cell

Client A wishes to access shared information on his cell. In the preferred embodiment of the present invention, client A sends a request to access his cell, The request comprises his login. The request is sent to the dispatch server 42. The dispatch server 42 which comprises a table with all the login and the corresponding cell identification. The dispatch server transmits the corresponding cell identification to client A. In the preferred embodiment of the present invention and as explained above, the cell identification comprises the IP address of the cell.

The client A then sends a request to authenticate with his cell. The request comprises his login and his password. The request is handled by the owner authentication unit 82. If the authentication is successful, client A is authenticated. Client A may then send a request to access a shared database 80. The request to access a shared database is sent to the database manager 86. The request to access a shared database comprises, in the preferred embodiment of the invention, the login of the user, and the name of a database, client A wishes to access. At this point, the database manager 86 upon reception of the request, checks with the owner authentication unit 82 if client A has already been authenticated. The database manager 86 then accesses the permission database 90 and performs a permission request. The permission request comprises the login of client A and the name of the shared database. It will be appreciated that client A accesses shared databases as he accesses his personal databases. If the client A does not know the name of the databases he is entitled to access, he has to access the owner database 94 using the profile manager 92 as explained above. In another embodiment of the invention, the permission database is accessed during the authentication.

An External User of the Cell Wishes to Access Shared Data on the Cell

Client B is not registered on the cell, but wishes to access data that client A shared to him.

In the preferred embodiment of the present invention, client B sends a request to access a database of client A, registered in the cell. The request comprises his login and the login of client A. The request is then sent to the dispatch server 42. The dispatch server 42 which comprises a table with all the login and the corresponding cell identification. The dispatch server transmits the corresponding cell identification of client A to client B. In the preferred embodiment of the present invention, the cell identification comprises the IP address of the cell. Client B then sends an authentication request to the shared access authentication unit 84. The authentication request comprises the name of the shared database the login of client B and its IP address in the preferred embodiment of the present invention. The shared access authentication unit 84 sends a permission request to the permission database 90, the permission request comprises the login of client B and the name of the shared database, client B wishes to access. A check is then performed in the permission database 90. If the check is successful, the shared access authentication unit authenticates client B for the shared database with permission rights. In another embodiment of the invention, the permission rights are not retrieved by the shared access authentication unit 84.

Client B may then wish to access the shared database. A connection is created between client B and the database manager 86 if a request to access a database is received after the authentication. The connection is created by sending the name of the database, the login of client B and the operation to be performed. The database manager 86 then performs an authentication checking request with the shared access authentication unit 84. The authentication checking request comprises the login of client B and the name of the database to be accessed and the operation to be performed. Upon successful authentication checking, the database manager 86 performs the desired operation and forward the requested information to client B.

The User Interface

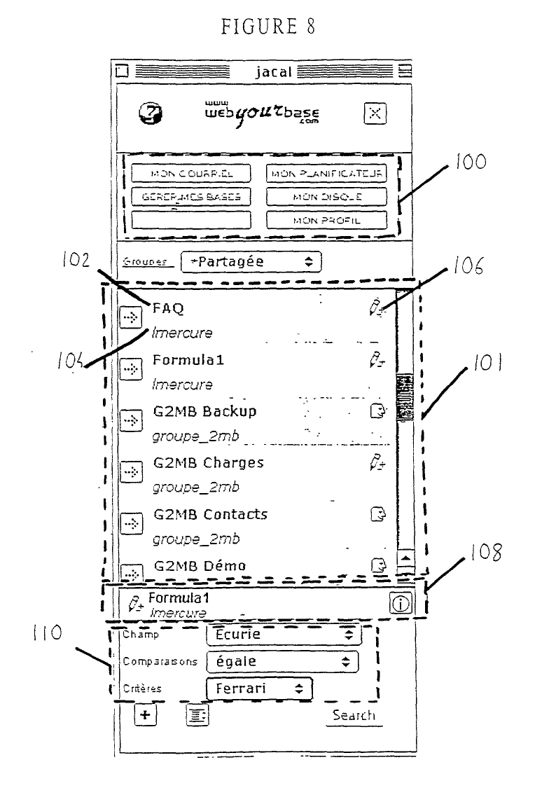

Now referring to FIG. 8, there is shown a copy of an interface provided by the owner resource access manager 88 to the user.

The interface comprises a group of application 100, a list of available databases 101, a selected database 108 and a dynamic search engine 110. The group of application comprises a profile manager 92. The profile manager 92 enables a user to modify the permission rights related to a database. By modifying a permission right for a particular database, the profile manager updates the permission database 90 according to the user's choice

The group of application 100 also comprises an email application which enables a user to access at least one existing email account as explained above. In the preferred embodiment of the present invention, the email application comprises, an inbox email database and a sent email database.

A file browser application enables a user to access his files stored in his directory on the drive server. In the preferred embodiment, the list of the files is stored in a database, the database comprises the name of the files, the type of each file, the size of each file, etc. The user might desire to upload files to his directory in the drive server. The user might be also able to download files. Therefore, a size quota might be created in order to avoid a drive server saturation. When an operation is performed that modify the files contained in the directory of the drive server, the file database is updated accordingly.

The group of application 100 also comprises a planning tool, which enables the user to create an entry for an event. The entry comprises for instance the type of event, the date, the time, the duration and an action to perform. The action might be an email reminder or any other type of reminder known in the Art. By accessing this application the user might be able to browse the current created events, to create new events or edit the existing events. It will be appreciated that the events are stored in an event database.

The group of application 100 also comprises a setup application. The setup application operates with the profile management module mentioned above. It enables the user to setup/update his account on the system. For instance, the user might select particular color preferences. The user might update some of its personal information such as his snail mail address, etc. The user might, at this point, enters the parameters of his email account(s).

The list of available databases 101 comprises for each available database the name of the database 102, the name of the owner 104 of the database or his login, in the preferred embodiment of the invention, and the permission right 106 for the user.

At least one selected database 108 is selected among the available database 101.

The dynamic search engine 110 enables the user to perform a search over the selected database 108. In the preferred embodiment of the present invention, the search is performed by selecting a field, a comparison operation and an operand. The dynamic search engine works with the search module of the cell.

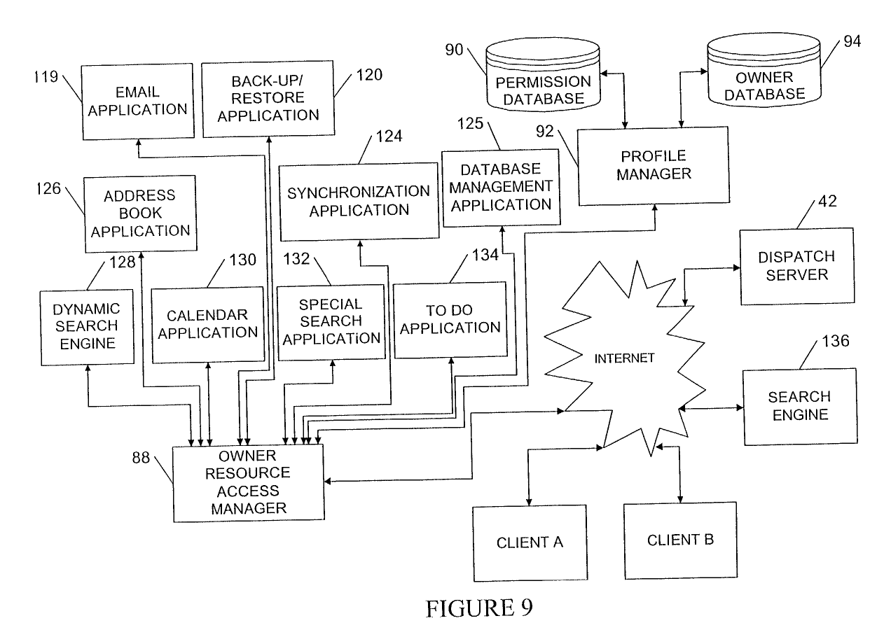

In another embodiment of the invention, the user interface may comprise a window dedicated to perform special searches using a special search application 132 as shown in FIG. 9. FIG. 9 shows more than one applications from the group of application 100 available to a user; these more than one applications are connected to the owner resource access manager. The more than one applications provides tools to the user. In such window, the user might choose to perform a search to be done and a destination database, For instance, the user might choose to perform a search in the “white pages” on the internet and choose to add the results of the search to one of his databases dedicated to his “personal contacts”. In this embodiment, the user may select at least a search engine 136, an input, a selected destination database and the fields to update in the selected database. In the preferred embodiment, the search engine 136 is a remote web server to which a request may be sent. The search is performed using at least the search engine 136 and the input in the preferred embodiment. Before the update of the selected database, the user may confirm the operation. This will prevent the system to update the database with unwanted information.

Still referring to FIG. 9, there is shown a database management application 125. The database management application 125 enables the user to perform operation on its databases available. The database management application 125 is an application which enables the user to perform operation using the database management module comprised in the cell (and shown in FIG. 4).

Security Features

Now referring back to FIG. 7 and in the preferred embodiment of the present invention, the user communicates with the dispatch server 42 and with the cell using a secure communication link. In the preferred embodiment of the present invention, the secure communication link is created using Secure Socket Layer (SSL). In the case of a WAP user, the secure communication link is created using the Wireless Transport Layer Security. In another embodiment of the invention, a public/private key encryption scheme may be used.

It will be appreciated that, in the preferred embodiment of the invention, and during the authentication with the cell, a number is generated and transmitted during all future transmissions between the system and the user. The number is generated preferably using at least clock ticks. The number allows the system to authenticate the user.

Furthermore, in the preferred embodiment, the user may have a “locker”. The “locker” may be created by generating a “locker password”. Once the “locker password” is generated, at least one database may be chosen and included in the “locker”. In the preferred embodiment, the at least one database chosen is not shared. The “locker password” is stored in the database of the user hosted by the cell. When a user wishes to access a database which is included in the “locker”, the database manager detects that the database is included in the “locker” and the user has to provide the “locker password”. If the user selects another database which is also included in the “locker”, the user may provide again the “locker password” in the preferred embodiment of the invention. This “locker password” will never be retransmitted to the user after its creation; therefore, this enables a higher level of security.

Backup/Restore Features

The user may perform a back-up of his databases using a back-up/restore application 120 as shown in FIG. 9. The back-up/restore application 120 enables also a user to import/export databases in order to use them with various commercial database software. The databases are formatted using techniques known by someone skilled in the Art in order to be compatible with the various commercial database software.

In another embodiment of the present invention, the user may synchronize two databases using a synchronization application 124 as shown in FIG. 9. The user may import a database in a cell and a comparison is performed with an existing related database located in a cell. The related database is then updated and both databases are then the same.

What is claimed is:

1. A computer network for storing user data and sharing at least a part of same among users with permission rights over a Wide Area Network (WAN), each of said users having a user identification, the computer network comprising:
a dispatch server, said dispatch server comprising a look-up table, said look-up table providing a relation between a user identification and a cell identification;
more than one cells, each of said more than one cells comprising,
an owner authentication unit, connected to said WAN, authenticating a local user and providing an owner authentication signal;
a shared database, said shared database comprising said shared data;
a permission database, the permission database comprising a relation between at least one user identification, at least one part of said data and said permission rights;
a shared access authentication unit, connected to said WAN, the shared access authentication unit authenticating a non local user using said permission database and providing a shared access authentication signal;
a database manager, connected to at least said owner authentication unit, to said shared access authentication unit, to said permission database and to said shared database, the database manager, receiving a request from a user and providing an access with permission right to at least one part of said shared data of said shared database with said permission rights if an owner authentication signal or if a shared access authentication signal is received.

2. The computer network as claimed in claim 1, further comprising a owner database, the owner database being connected to said database manager, the owner database comprising an identification of the database available to a particular user.

3. The computer network as claimed in claim 2, further comprising a owner resource access manager, the owner resource access manager enabling a local user access to access at least one application, said at least one application using at least one database.

4. The computer network as claimed in claim 3, wherein said owner resource manager enables said local user to access at least one application, using an interface, said interface comprising at least one function button, each of said at least one function button providing access to one of said at least one application, a list all database available to a user, said list comprising the name of said database available, the owner and the permission status.

5. The computer network as claimed in claim 4, wherein said interface comprises a dynamic search engine and a database selection tools, said database selection tools enabling said user to select at least one database of said database available, said dynamic search engine enabling said user to perform a search over said at least one selected database using at least one database search technique.

6. The computer network as claimed in claim 5, wherein said at least one database search technique comprises a boolean search.

7. The computer network as claimed in claim 3, wherein one of said at least one application comprises a profile manager, said profile manager enabling a user to modify a permission right for at least one part of his data.

8. The computer network as claimed in claim 3, wherein one of said at least one application comprises a database management application, the database management application enabling the user to create, edit, delete a database.

9. The computer network as claimed in claim 3, wherein one of said at least one application comprises a calendar.

10. The computer network as claimed in claim 3, wherein one of said at least one application comprises a to do application, said to do application enabling at least a user to create a list of item to complete according to its preference.

11. The computer network as claimed in claim 3, wherein one of said at least one application comprises an address book application, said address book application enabling a user to create a list of addresses.

12. The computer network as claimed in claim 4, wherein said interface comprises a special search engine, said special search engine enabling said user to select a search application, at least one database of said database available and a search data, said special search engine enabling said user to perform a search using said search application with said search data and to update said at least one database with at least one part of the results from said search.

13. The computer network as claimed in claim 12, wherein said search application is embedded on a remote web server.

14. The computer network as claimed in claim 3, wherein one of said at least one application comprises a synchronization application, the synchronization application enabling a user to synchronize at least two databases.

15. The computer network as claimed in claim 3, wherein one of said at least one application comprises a back-up/restore application, the back-up/restore application enabling a user to perform a back-up/restore of at least one database.

16. The computer network as claimed in claim 1, wherein authentication is performed using at least a login and a password.

17. The computer network as claimed in claim 1, wherein said relation between a user identification and a cell identification is provided using encryption means.

18. The computer network as claimed in claim 1, wherein said request from a user is received by said database manager using encryption means.

19. The computer network as claimed in claim 1, wherein said database manager and said client are connected via said WAN using encryption means.

20. The computer network as claimed in claim 1, wherein said shared database comprises an alarm field.

21. The computer network as claimed in claim 20, wherein a cell comprises an alarm watchdog, the alarm watchdog monitoring the alarm field of the shared database on the cell.

22. A method for sharing at least one part of data, using a plurality of cell, among at least one user with permission rights over a Wide Area Network (WAN), each of said users having a user identification, the method comprising the steps of:
accessing a dispatch server, said dispatch server comprising a look-up table, said look-up table providing a relation between a user identification and a cell identification;
providing a user identification to said dispatch server;
receiving, from said dispatch server, a cell identification corresponding to said user identification provided;
accessing a cell through said WAN, using said cell identification;
authenticating with said cell using at least said user identification and a password;
selecting said at least one part of data to share;
selecting said at least one user to whom said at least one part of data is shared and a permission right;
updating a permission database using at least said permission right, the user identification of said at least one user to whom the at least one part of data is shared and an identification of said shared data.

23. The method as claimed in claim 22, further comprising the step of sending an information to said at least one user to whom the data is shared, said information comprising said user identification and an identification of said shared data.

24. The method as claimed in claim 22, further comprising the step of generating a number after said authentication with said cell, said number being transmitted in following transmissions in order to enable a continuous authentication of said user.

25. The method as claimed in claim 22, further comprising the step of detecting when a cell reaches a certain limit.

26. The method as claimed in claim 25, further comprising the step of transferring at least one part of said data of a cell in another cell.

27. The method as claimed in claim 26, wherein the step of transferring at least one part of said data of a cell in another cell is performed by updating the dispatch server, updating the permission database and copying the data.
